(19) United States
(12) Patent Application Publication
(10) Pub. No.: US 2004/0101256 A1
(43) Pub. Date: May 27, 2004

(54) Optical fiber connector

(75) Inventors: Yih-Long Lin, Hsinchu (TW); Kuo-Chin Huang, Hsinchu (TW); Fan-Chieh Chang, Hsinchu (TW)

Correspondence Address: BACON & THOMAS, PLLC, 625 SLATERS LANE, FOURTH FLOOR, ALEXANDRIA, VA, 22314

(73) Assignee: Coretronic Corporation, Hsinchu (TW)

(21) Appl. No.: 10/630,743

(22) Filed: Jul. 31, 2003

(30) Foreign Application Priority Data
Nov. 21, 2002 (TW) 091219080

(51) Int. Cl. G02B 6/36

(52) U.S. Cl. 385/88

(57) ABSTRACT

The present invention provides an optical fiber connector connected to a printed circuit board. The optical fiber connector comprises a main body and a supporting bracket. The main body has an inserted surface and a jointed surface arranged opposite to each other, the inserted surface comprises a fiber groove, and the jointed surface is faced with the printed circuit board. The supporting bracket has a top-surface and at least two side surfaces. One end of the side surface connects to said top surface and the other end of the side surface extends to form a piece. Thus, the piece is fastened into the printed circuit board to form a 180-angled optical fiber connector. The optical fiber transmitting lines can be perpendicularly inserted into the optical fiber connector. It also economizes the molding cost and manufacturing time.

### BACKGROUND OF THE INVENTION

1. Field of the Invention

The present invention relates to a connector, and more particularly to an optical fiber connector for use in a fibertransmission.

2. Description of the Related Art

The optical fiber has the features of great bandwidth, low transmission loss, and steadiness against electromagnetic wave. Therefore, the optical fiber can be used for transmitting the signal communication, net, and multimedia. The optical fiber can provide great and high quality signals.

The apparatus of communication, net, multimedia have the optical fiber connector for signal transmitting. As shown in FIG. 1, a conventional 90-angled optical fiber connector 11 comprises an inserted surface 111 and a jointed surface 112, perpendicular to each other. The inserted surface 111 has grooves 1111 for plugging the optical fiber transmitting line (not shown). The jointed surface 112 is closed horizontally to a printed circuit board 12. The jointed surface 112 has a plurality of plugs 1121 and pins 1122. The optical fiber connector 11 is fastened on the printed circuit board 12 by plugging the plugs 1121 into the holes 121 of the printed circuit board 12. The pins 1122 is electric connection with the printed circuit board 12, and the optical fiber transmitting line is plugged into grooves 1111 along the direction of the printed circuit board 12.

For the need of beautiful look, thinness, and lightness, the location of the printed circuit board is different. As shown in FIG. 2, for example, a Digital Video Disk player 1 has a printed circuit board 12A positioned horizontally. The transmitting lines can be plugged into the grooves 1111A so that the conventional 90-angled optical fiber connector 11 can be used. As shown in FIG. 3, for example, a rear-projection TV has a printed circuit board 12B positioned vertically to thin its body. The transmitting lines must be plugged into the grooves 11B perpendicular to the printed circuit board 12B and, thus, the conventional 90-angled optical fiber connector 11 can't be used. To resolve the problem, the prior art uses a L-shaped optical fiber connector to switch the direction or re-molding to fabricate a 180-angled optical fiber connector. However, the L-shaped optical fiber connector occupies too much space and re-molding raises the cost.

### SUMMARY OF THE INVENTION

An object of the present invention is to provide an optical fiber connector, which allows the optical fiber transmitting lines can be perpendicularly inserted into the optical fiber connector so that the space is saved and the connection is convenient.

Another object of the present invention is to provide an optical fiber connector, which uses the conventional 90-angled optical fiber connector and a supporting bracket to change the direction of the grooves to form a 180-angled optical fiber connector and, thus, it economizes the molding cost and manufacturing time.

To achieve the above objects, the present invention provides an optical fiber connector which can be connected to a printed circuit board. The optical fiber connector comprises a main body and a supporting bracket. The main body has an inserted surface and a jointed surface arranged opposite to each other. The inserted surface comprises a fiber groove, and the jointed surface is faced with the printed circuit board. The supporting bracket has a top-surface and at least two side surfaces, with one end of the side surface connecting to the top surface and the other end of the side surface extending to form a piece, and, thus, the piece is fastened into the printed circuit board to form a 180-angled optical fiber connector.

### BRIEF DESCRIPTION OF THE DRAWINGS

The above and other objects, advantages, and features of the present invention will be understood from the following detailed description of the invention when considered in connection with the accompanying drawings below.

FIG. 1 is a decomposed view showing a 90-angled optical fiber connector and a printed circuit board of the prior art.

FIG. 2 is a perspective view showing a Digital Video Disk player of the prior art.

FIG. 3 is a perspective view showing rear-projection TV of the prior art.

FIG. 4 is a perspective view showing an optical fiber connector of the present invention.

FIG. 5 is an explored view showing an optical fiber connector of the present invention.

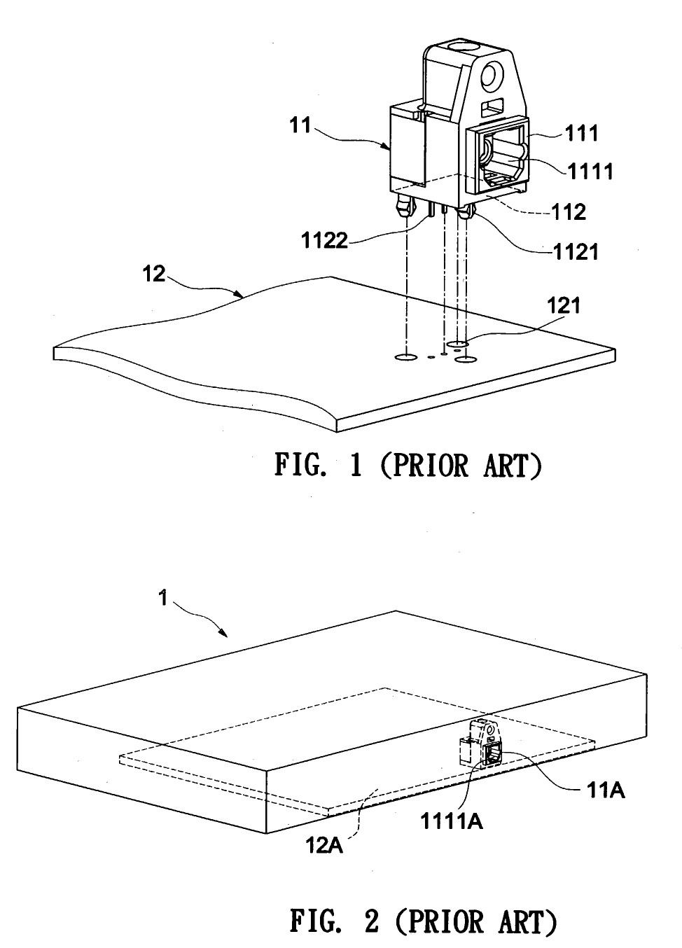

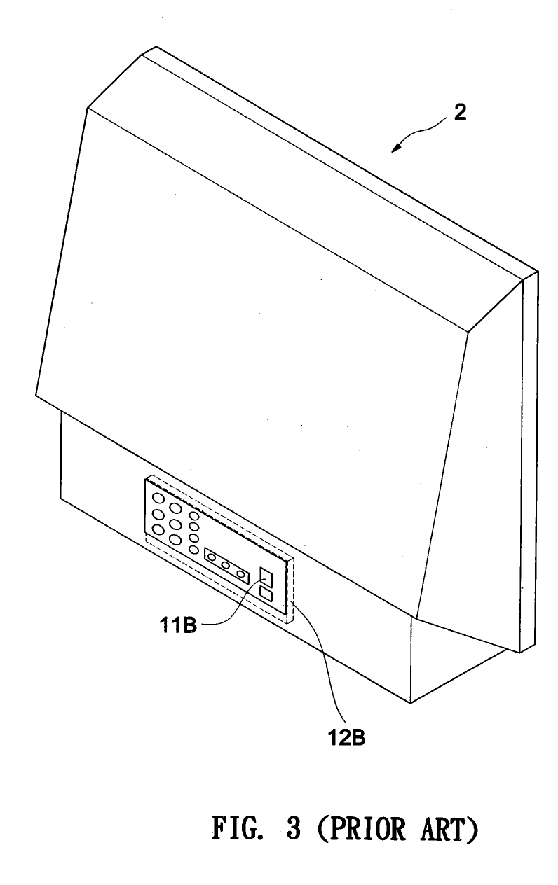

### DETAILED DESCRIPTION OF THE INVENTION

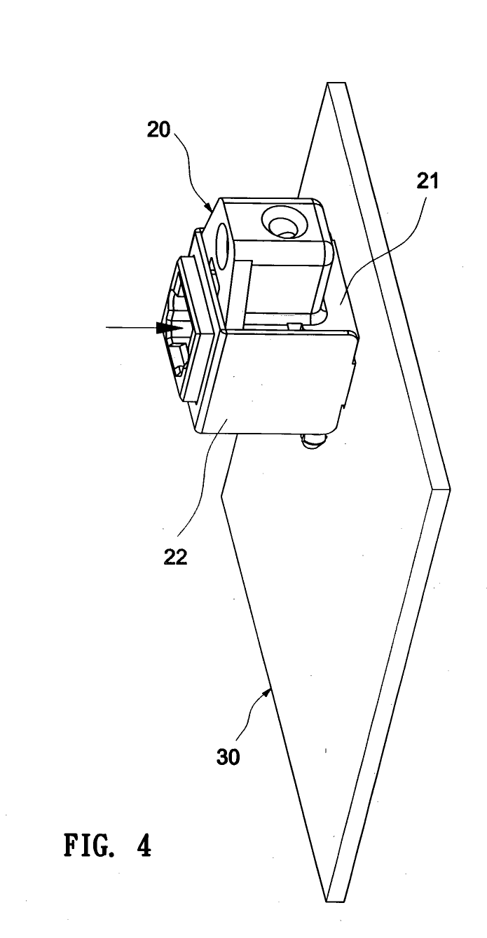

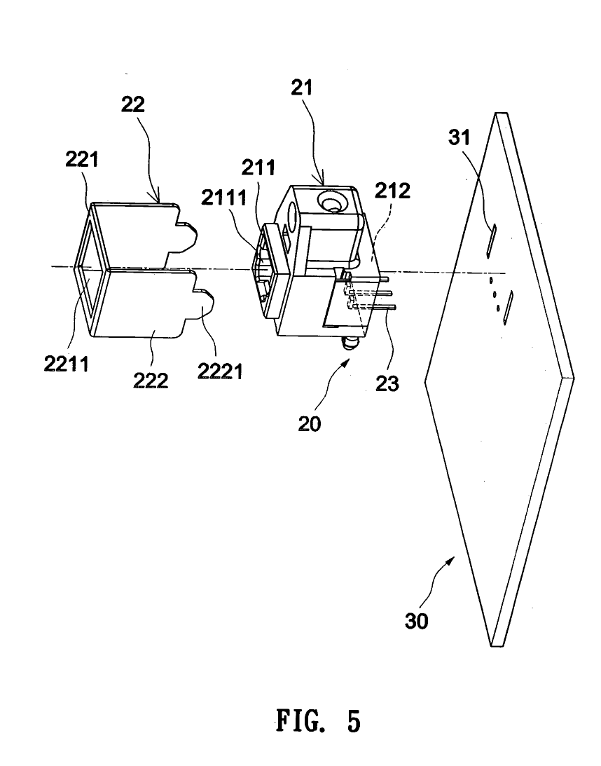

Referring to FIG. 4, an optical fiber connector 20 of the present invention comprises a main body 21 and a supporting bracket 22. The optical fiber connector 20 connects with a printed circuit board 30. Referring to FIG. 5, the main body 21 has an inserted surface 211 and a jointed surface 212 arranged opposite to each other. The inserted surface 211, that protrudes from the top surface of the main body 21, has a groove 2111 for being locked into the plug of fiber transmitting line (not shown). The jointed surface 212 is close and faced with a printed circuit board 30. Thus, the fiber transmitting line can be plugged into the groove 2111 along the direction of arrow, perpendicular to the printed circuit board 30. The supporting bracket 22 is extending along the main body 21 and covers the main body 21. The supporting bracket 22 comprises a top surface 221 and at least two side surfaces 222, connected with the top surface 221. The supporting bracket 22 is a [symbol] shape formed with the top surface 221 and the side surfaces 222. The top surface 221 opens a window 2211 which is bigger than the groove 2111. One end of the side surface 222 is connected with the top surface 221, and the other end of the side surface 222 is extended to form a piece 2221. The printer circuit board 30 has holes 31 corresponding to the location, number, and size of the pieces 2221. In addition, the length of the side surface 222 corresponds with the distance from the inserted surface 211 to the jointed surface 212. By positioning the supporting bracket 22 from the top of groove 2111, the pieces 2221 are plugged into holes 31 and, then, welded on the printed circuit board 30 so that the main body 21 won't be loosened.

Referring to FIG. 5 the fabricating process for an optical fiber connector 20 of the present invention is described below. Firstly, a conventional 90-angled fiber connector 11 is provided. Bend the pins 1122 of the fiber connector 11, 90 degree toward the jointed surface 212. The pins 1122 are perpendicular to the jointed surface 212 to become the pins 32 of the optical fiber connector 20 of the present invention. The groove 2111 of the optical fiber connector 20 is positioned on the printed circuit board 30 having a plurality of holes 31. By positioning the [symbol] -shaped supporting bracket 22 having the two pieces 2221 from the top of groove 2111, the pieces 2221 are plugged into holes 31. The inserted surface 211 is inserted into, limited and fastened to the window 2211.Then, weld the pieces 2221 of the optical fiber connector 20 on the printed circuit board 30, and electrically connect the pins 32 with the printed circuit board 30 to construct a 180-angled optical fiber connector of the present invention (As shown in FIG. 4). The present invention bents the pins of a conventional 90-angled optical fiber connector and provides a supporting bracket to change the direction of the grooves of the optical fiber connector. Thus it economizes the molding cost and manufacturing time. In addition, the supporting bracket is a thin piece so that it won't increase the space of the optical fiber connector.

It will be apparent to those skilled in the art that in light of the forgoing disclosure, many alternations and modifications are possible in the practice of this invention without departing from the spirit or scoop thereof. Accordingly, the scoop of the invention is to be considered in accordance with the substance defined in the following claims.

What is claimed is:

1. An optical fiber connector, comprising:
a main body having an inserted surface and a jointed surface arranged opposite to each other, said inserted surface comprising a fiber groove, said jointed surface facing a printed circuit board; and
a supporting bracket covering said main body and having a top surface and at least two side surfaces, which one end of said side surface connects to said top surface and the other end of said side surface extends to form a piece, said piece being fastened into said printed circuit board.

2. An optical fiber connector according to claim 1, wherein said supporting bracket is [symbol] shape formed with said top surface and two side surfaces.

3. An optical fiber connector according to claim 1, wherein said top surface further comprises window corresponding to said fiber groove.

4. An optical fiber connector according to claim 1, wherein the length of said side surface corresponds with the distance from said inserted surface to said jointed surface.

5. An optical fiber connector according to claim 1, wherein said main body further comprises a plurality of pins.

6. An optical fiber connector according to claim 5, wherein said pins can be bended to connect said jointed surface vertically.
